(19) United States
(12) Patent Application Publication
(10) Pub. No.: US 2023/0244441 A1
(43) Pub. Date: Aug. 3, 2023

(54) ELECTRONIC DEVICE AND CONTROL METHOD THEREFOR

(71) Applicant: SAMSUNG ELECTRONICS CO., LTD., Suwon-si (KR)

(72) Inventors: Byeoungwook KIM, Suwon-si (KR); Dongsoo LEE, Suwon-si (KR); Sejung KWON, Suwon-si (KR); Yeonju RO, Suwon-si (KR); Baeseong PARK, Suwon-si (KR); Yongkweon JEON, Suwon-si (KR)

(73) Assignee: SAMSUNG ELECTRONICS CO., LTD., Suwon-si (KR)

(21) Appl. No.: 18/131,164

(22) Filed: Apr. 5, 2023

Related U.S. Application Data
(63) Continuation of application No. PCT/KR21/11740, filed on Sep. 1, 2021.

(30) Foreign Application Priority Data
Oct. 5, 2020 (KR) 10-2020-0127980

(51) Int. Cl. G06F 5/01; G06F 7/487; G06F 7/485; G06F 7/544

(52) U.S. Cl. CPC G06F 5/01; G06F 7/4876; G06F 7/485; G06F 7/5443

(57) ABSTRACT

An electronic device and a control method therefor are disclosed. An electronic device of the present disclosure includes a processor, which quantizes weight data with a combination of sign data and scaling factor data to obtain quantized data, and may input the first input data into a first module to obtain second input data in which exponents of input values included in the first input data are converted to the same value; input the second input data and the sign data into a second module to determine the signs of input values and perform calculations between the input values of which signs are determined to obtain first output data; input the first output data into a third module to normalize output values included in the first output data; and perform a multiplication operation on data including the normalized output values and the scaling factor data to obtain second output data.

### CROSS-REFERENCE RELATED TO APPLICATIONS

The present application is a bypass continuation of International Application No. PCT/KR2021/011740, filed on Sep. 1, 2021, in the Korean Intellectual Property Receiving Office, which is based on and claims priority from Korean Patent Application No. 10-2020-0127980 filed on Oct. 5, 2020, the entire disclosures of which are incorporated herein by reference.

### TECHNICAL FIELD

The present disclosure relates to an electronic device and a control method therefor, and more particularly, to an electronic device for accelerating calculations for weights and input data on an artificial intelligence model and a control method therefor.

### BACKGROUND

Recently, research and development on artificial intelligence systems that implement human-level intelligence have been conducted. The artificial intelligence system refers to a system that performs training and inferring based on a neural network model unlike an existing rule-based system, and has been utilized in various fields such as voice recognition, image recognition, and future prediction.

In particular, recently, an artificial intelligence system that solves a given problem through a deep neural network based on deep learning has been developed.

A deep neural network is a neural network that includes a plurality of hidden layers between an input layer and an output layer, and refers to a model that implements artificial intelligence technology through calculations between weight values and input data included in each layer. It is common for deep neural networks to include a plurality of weight values in order to derive accurate result values.

On the other hand, since the deep neural networks contain a huge amount of weight values, a problem occurs that resources required for calculation gradually increase. In addition, when the calculation is compressed or simplified on the deep neural network, a problem occurs that the accuracy of the calculation may decrease.

### SUMMARY

The present disclosure relates to an electronic device for performing calculation between weight data and input data based on artificial intelligence technology and a control method therefor.

According to an aspect of the present disclosure, an electronic device may include: a memory configured to store first input data and weight data used for calculation of a neural network model; and a processor configured to quantize the weight data with a combination of sign data and scaling factor data to obtain quantized data, in which the processor further configured to input the first input data to a first module to obtain second input data in which exponents of input values included in the first input data are converted into a same value; input the second input data and the sign data to a second module to determine signs of the input values included in the second input data, and perform calculations between the input values of which signs are determined to obtain first output data; input the first output data to a third module to normalize output values included in the first output data, and perform a multiplication operation on data including the normalized output values and the scaling factor data to obtain second output data.

According to another aspect of the present disclosure, a method of controlling an electronic device including a memory that stores first input data and weight data used for calculation of a neural network model may include: quantizing the weight data with a combination of sign data and scaling factor data to obtain quantized data; inputting the first input data to a first module to obtain second input data in which exponents of input values included in the first input data are converted into a same value; inputting the second input data and the sign data to a second module to determine signs of the input values included in the second input data, and performing calculation between the input values of which signs are determined to obtain first output data; inputting the first output data to a third module to normalize output values included in the first output data, and performing a multiplication operation on data including the normalized output values and the scaling factor data to obtain second output data.

As described above, according to various embodiments of the present disclosure, an electronic device may efficiently perform calculation between a weight value and input data on a terminal device including limited resources.

### BRIEF DESCRIPTION OF DRAWINGS

FIG. 1 is a block diagram schematically illustrating a configuration of an electronic device according to an embodiment of the present disclosure.

FIG. 2 is an exemplary block diagram for an electronic device performing calculation between input data and weight data according to an embodiment of the present disclosure.

FIG. 3 is an exemplary diagram illustrating a process of quantizing weights by an electronic device according to an embodiment of the present disclosure.

FIG. 4 is a block diagram illustrating a configuration of an electronic device in detail according to an embodiment of the present disclosure.

FIG. 5 is a flowchart illustrating a process of controlling an electronic device according to an embodiment of the present disclosure.

### DETAILED DESCRIPTION

The present disclosure provides an electronic device that quantizes weight values included in weight data to obtain quantized data and performs calculations between data obtained by aligning exponents of all input data and the quantized data to obtain output data, and a control method therefor.

The electronic device of the present disclosure may quantize weight data with sign data and scaling factor data to reduce a floating-point multiplication calculation process required to perform calculation between weight data and input data.

In addition, the electronic device may include only an integer-based add circuit in a calculation module for performing calculation of the input data and the weight data by aligning the exponents of all the input data. Therefore, the electronic device may increase the efficiency of calculation by mainly using an integer-based add circuit while obtaining output data for weight data and input data with floating-point.

Hereinafter, the disclosure will be described in detail with reference to the

drawings.

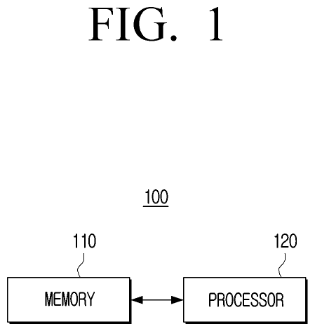

FIG. 1 is a block diagram schematically illustrating a configuration of an electronic device 100 according to an embodiment of the present disclosure. As illustrated in FIG. 1, the electronic device 100 may include a memory 110 and a processor 120. However, the configuration illustrated in FIG. 1 is an exemplary diagram for implementing the embodiments of the present disclosure, and the electronic device 100 may additionally include appropriate hardware and software configurations that are obvious to those skilled in the art.

Meanwhile, in describing the present disclosure, the electronic device 100 is a device for obtaining output data for input data by learning, compressing, or using a neural network model of a neural network model (or artificial intelligence model), and for example, the electronic device 100 may be implemented as a desktop PC, a laptop computer, a smart phone, a tablet PC, a server, and the like.

In addition, various operations performed by the electronic device 100 may be performed by a system in which a cloud computing environment is built. For example, the system in which the cloud computing environment is built may quantize weights included in the neural network model and perform calculation between quantized data and input data.

The memory 110 may store commands or data related to at least one other component of the electronic device 100. In addition, the memory 110 is accessed by the processor 120, and readout, recording, correction, deletion, update, and the like, of data in the memory 110 may be performed by the processor 120.

In the present disclosure, the term “memory” may include the memory 110, a ROM (not illustrated) or a RAM (not illustrated) in the processor 120, or a memory card (not illustrated) (for example, a micro secure digital (SD) card or a memory stick) mounted in the electronic device 100. In addition, programs, data and the like, for configuring various screens to be displayed on a display region of a display may be stored in the memory 110.

In addition, the memory 110 may include a volatile memory with which should be continuously supplied with power so as to maintain stored information in the non-volatile memory capable of maintaining stored information even if the supply of power is cut off. For example, the non-volatile memory may be implemented as at least one of a one time programmable ROM (OTPROM), a programmable ROM (PROM), an erasable and programmable ROM (EPROM), an electrically erasable and programmable ROM (EPROM), a mask ROM, and a flash ROM, and the volatile memory may be implemented as at least one of a dynamic RAM (DRAM), a static RAM (SRAM), and a synchronous dynamic RAM (SDRAM).

The memory 110 may store weight data used for calculation of the neural network model. That is, the memory 110 may store a plurality of weight data included in a plurality of layers constituting a neural network model.

The weight data may include a plurality of weight values included in the weight data. In this case, the weight value may be implemented in an n (n is a natural number greater than or equal to 1) bit floating-point format. For example, the weight data may be implemented as a 32-bit floating-point. The weight data may be represented by at least one of a vector, a matrix, or a tensor.

The memory 110 may store quantized data in which the weight data is quantized with a combination of sign data and scaling factor data. The quantized data may be represented by at least one of the vector, matrix, or tensor according to a format of weight data.

The sign data may include 1 or −1, which is a sign value capable of determining only the sign without changing the size of the scaling factor. The scaling factor data may be represented by the floating-point format (e.g., 32-bit floating-point format) similar to the weight data format. A method of quantizing weight data will be described in a later section.

The memory 110 may store various types of input data. For example, the memory 110 may store voice data input through a microphone, image data, text data, or the like that is input through an input unit (e.g., a camera, a keyboard, etc.). The input data stored in the memory 110 may include data received through an external device.

The memory 110 may store data necessary for a first module 10, a second module 20, and a third module 30 to perform various operations. Data necessary for the first module 10, the second module 20, and the third module 30 to perform various operations may be stored in the non-volatile memory. Each module will be described in the following section.

The processor 120 may be electrically connected to the memory 110 to control overall operations and functions of the electronic device 100. The processor 120 may be composed of one or a plurality of processors to control the operation of the electronic device 100.

The processor 120 may load data necessary for the first module 10, the second module 20, and the third module 30 to perform various operations from a non-volatile memory to a volatile memory. Loading refers to an operation of loading and storing into, the volatile memory, the data stored in the non-volatile memory so that the processor 120 may access.

In addition, the volatile memory, which is a component of the processor 120, may be implemented as a form included in the processor 120, but this is only one embodiment, and the volatile memory may be implemented as a component separate from the processor 120.

The processor 120 may obtain quantized data by quantizing weight data. Quantizing the weight means simplifying units of weight or expressing the units of weight in a different way in order to efficiently use the weight.

For example, the processor 120 may obtain quantized data by performing quantization of a binary coding method on the weight values included in the weight data. The processor 120 may store the obtained quantized data in the memory 110. Performing the quantization of the binary code method on the weight values means that the weight values are quantized with the combination of the sign data and the scaling factor data.

For example, performing the quantization of the binary coding method on the weight values based on k (k is a natural number greater than or equal to 1) bits means representing weights in a way of summing products of k sign values and scaling factors.

When k is 3, the weight data may be quantized as shown in Equation 1 below. In Equation 1, W denotes the weight data, A denotes the scaling factor data, and B denotes the sign data.

$$W \approx {\sum }_{K = 1}^{3} {A}_{k} {B}_{k} \qquad [ Equation 1 ]$$

Based on quantization being performed on weights using the binary coding method, the processor 120 may determine a k value based on an accuracy level required when calculating a neural network model. Since the weight may be represented more accurately as the k value increases, the k value may be determined as a larger value to increase the accuracy of output data obtained through the neural network model.

Accordingly, based on the accuracy level required for performing the calculation of the neural network model being high, the processor 120 may determine the k value as a high value. The accuracy level required when performing the calculation of the neural network model may be determined according to the type of input data or may be determined when a user designs the neural network model.

For example, based on the input data being language data or voice data requiring high calculation accuracy, the processor 120 may determine the k value as 5, and based on the input data being image data requiring relatively low calculation accuracy, the processor 120 may determine the k value as 3. However, this is only an example, and the k value corresponding to each type of input data may be allocated and may be freely changed by the user.

As described above, the quantization of the weight data may be performed by the processor 120 of the electronic device 100. However, the quantization of the weight data is not limited thereto, and may be performed by an external device (e.g., a server). Based on the quantization of the weight data being performed by the external device, the processor 120 may receive quantized data including quantized weight values from the external device and store the received quantized data in the memory 110.

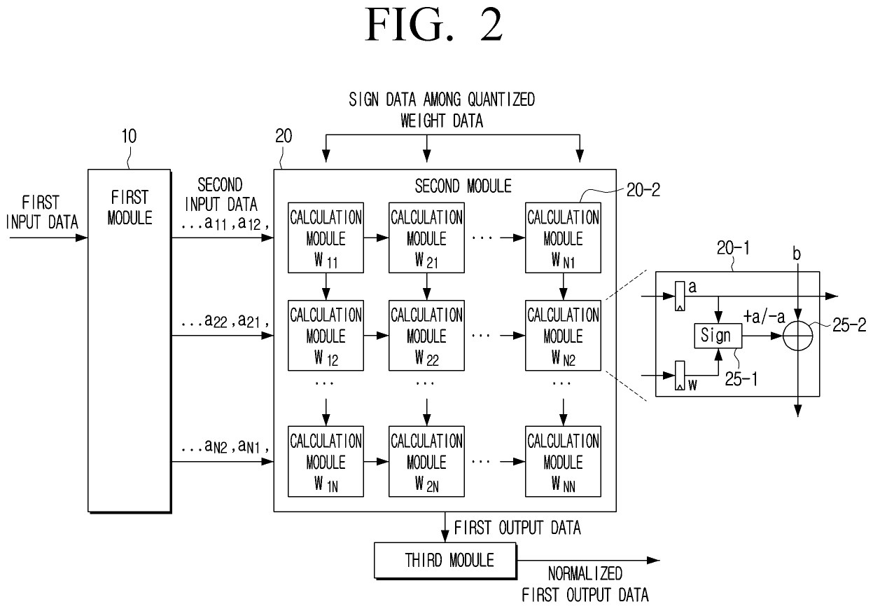

A process of acquiring the second output data by the processor 120 based on the quantized data and the first input data will be described in detail with reference to FIG. 2. FIG. 2 is a diagram for describing an operation and structure in which the processor 120 of the electronic device 100 accelerates matrix multiplication between quantized data and first input data according to an embodiment of the present disclosure.

The processor 120 may input the first input data to the first module 10 to obtain second input data in which exponents of input values included in the first input data are converted into the same value.

The first module 10 means a module that changes (or aligns) exponents of all input values included in the first input data to the same value, and may be represented as an exponent alignment module. The first module 10 may be implemented as a hardware module, but is not limited thereto and may also be implemented as a software module.

The processor 120 may identify a minimum exponent of the input values included in the first input data through the first module 10 and convert the exponents of the input values included in the first input data into the identified minimum exponent value to obtain the second input data.

For example, assuming that the input values are 2\hat{ }(−3 )*1.25, 2\hat{ }(−1 )*1.75, and 2\hat{ }(1)*1.0, the processor 120 may identify that the minimum value among the exponents of the input values is −3 through the first module 10. Then, the processor 120 may change (or align) the exponent of all the input values to −3 through the first module 10 to obtain the input values 2\hat{ }(−3)*1.25, 2\hat{ }(−3)*7.0, 2\hat{ }(−3)*16.

However, this is only one embodiment, and the processor 120 may change (or align) the exponent of the input value included in the input data to a preset value through the first module 10. The preset value may be a value set by a user and may be changed in various ways.

Conventionally, an operation in which the exponents of all the input values included in the first input data are not aligned as the same value before inputting to the calculation module but exponents of two input values are aligned as the same value when performing the sum calculation of the two input values is performed each time. For example, based on the input values included in the input data being 1000, and the sum calculation of each input value being performed a million times, the operation of aligning the exponents of each input data should be performed a million times.

However, the processor 120 of the electronic device 100 of the present disclosure aligns the exponents of all the input values included in the input data through the first module 10 as the same value, so that the circuit that aligns the exponent of the input value on the second module 20 may be excluded.

For example, based on the input values included in the input data being 1000 and the sum calculation of each input value being performed a million times, the processor 120 performs the operation of aligning the exponent of the input data through the first module a thousand times.

The processor 120 may obtain an output value by performing the calculation between the second input data whose exponents are aligned as the same value and the quantized sign data of the weight data, and then performing the calculation between the calculation result data, the output data, and the scaling factor data.

For example, as shown in Equation 2 below, it is assumed that the binary coding method is quantized with a weight W of 3 bits.

WX≈(A₀B₀+A₁B₁+A₂B₂)*X [Equation 2]

In Equation 2, A denotes the scaling factor data, B denotes the sign data, and X denotes the input data. The processor 120 may first calculate the input data X on each of B₀, B₁, and B₂ according to a distributive law, and then calculate the calculation result data and the scaling factor data A₀, A₁, and A₂, thereby obtaining an output value.

In this case, since B₀, B₁, and B₂ are data included with a sign value of −1 or 1, the calculation between the input data X and B₀, B₁, and B₂ may mean a process of determining the sign of the input data.

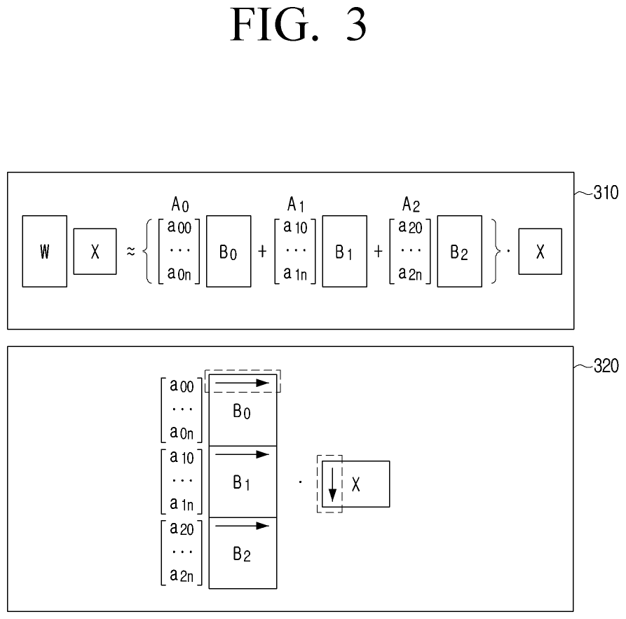

The situation for Equation 2 is shown in more detail in identification item 310 of FIG. 3. 310 is a case where A₀, A₁, and A₂ are implemented in a 1×N matrix. As illustrated in the identification item 320, the processor 120 may determine the sign of the input data by first performing calculation on the input data X and each of B₀, B₁, and B₂ according to the distribution law.

Hereinafter, the process of obtaining the first output data by the processor 120 using the second module 20 will be described.

The processor 120 may input the quantized sign data of the weight data and the second input data obtained by aligning the exponents as the same value to the second module 20, determine the sign of the input value included in the second input data, and perform the calculation between the input values of which signs are determined, thereby obtaining the first output data.

As illustrated in FIG. 2, the second module 20 may include a plurality of calculation modules having a systolic array. The systolic array refers to an array designed to perform one calculation according to a synchronization signal by configuring a connection network of modules and the like having the same function.

The calculation module 20-1 included in the second module 20 may include a sign determination circuit 25-1 that determines a sign of second input data using sign data, and a calculation circuit 25-2 that performs the sum calculation between the input values included in the second input data of which signs are determined. In this case, the calculation circuit 25-2 may be implemented as a circuit that performs integer-based sum calculation.

That is, the existing multiplier-accumulator unit (MAC) includes a calculation circuit that multiplies and adds the weight value in the floating-point format and the input value. The calculation module 20-1 of the present disclosure may include only a calculation circuit that performs one integer-based calculation, excluding the calculation circuit included in the existing MAC.

In other words, since the calculation module 20-1 includes a calculation circuit that performs simpler calculations than the existing MAC, an area occupied by the calculation module 20-1, the power consumed, and the amount of calculation may be reduced.

As illustrated in FIG. 2, the processor 120 may input a first input value a among the second input data to the sign determination module 25-1 among the calculation module 20-1 and the corresponding sign value w to the calculation module 20-1 among the sign data, thereby determining the sign of the first input value a. Since the sign value w is either −1 or 1, the first input value a may be determined as either a negative sign or a positive sign.

The processor 120 may input the first input value +a or −a of which signs are determined and the second input value b output from the calculation module 20-2 disposed above the calculation module 20-1 on the systolic array to the calculation circuit 25-2, thereby acquiring the sum of the first input value and the second input value.

That is, since the weight data is quantized with the sign data, the processor 120 may only perform the sum calculation between the scaling factor data and the input data whose sign is determined by the sign data before the multiplication operation is performed. Since the exponents of the input data for which the sum calculation of which signs are determined is to be performed are aligned, the processor 120 may perform the sum calculation on a mantissa (mantissa) part of the input data through the integer-based sum calculation circuit 25-2, thereby obtaining the first output data.

The processor 120 may input the first output data obtained through the second module 20 to the third module 30 to normalize the output value included in the first output data. The third module may be represented as a normalization module.

Specifically, the processor 120 may change a first digit of the mantissa of the output value included in the first output data to be a one-digit natural number smaller than a base to normalize the output value included in the first output data. For example, based on the output value being −0.8*2\hat{ }(−1), the processor 120 changes the first digit of the mantissa to be a one-digit natural number smaller than the base 2 to normalize the output value to −1.6*2\hat{ }(−2).

The processor 120 may input the first output data output from the second module 20 to the third module 30 to normalize the first output data, thereby excluding a circuit that performs the normalization on each calculation module having the systolic array.

That is, in the past, the process of normalizing the sum calculation result value output from a plurality of MACs each time was performed. For example, based on the input values included in the input data being 1000, and the sum calculation of each input value being performed a million times, the normalization operation of normalizing the calculation result value should be performed a million times.

However, the processor 120 of the electronic device 100 of the present disclosure may reduce the number of times of the normalization operation by normalizing the output value of the calculation module through the third module. For example, based on the input values included in the input data being 1000 and the sum calculation of each input value being performed a million times, the processor 120 performs the operation of normalizing the calculation result value through the third module 30 only a thousand times. Accordingly, it is possible to reduce the area occupied by the circuit performing the normalization operation and the calculation amount or power consumption required to perform the normalization operation.

The processor 120 may perform the multiplication operation on the data including the normalized output values and the scaling factor data to obtain the second output data. That is, the processor 120 may perform the calculation between the weight data and the input data using the first module 10, the second module 20, and the third module 30 to obtain the second output data.

Meanwhile, functions related to artificial intelligence according to the present disclosure are operated through the processor 120 and the memory 110. The processor 120 may include one or more processors. In this case, one or more processors are general-purpose processors such as a central processing unit (CPU), an application processor (AP), and a digital signal processor (DSP), graphics-dedicated processors such as a graphic processing unit (GPU) and a vision processing unit (VPU), or artificial intelligence-dedicated processors such as a neural processing unit (NPU).

One or more processors 120 perform control to process input data according to a predefined operation rule or artificial intelligence model stored in the memory 110. Alternatively, when one or more processors are the artificial intelligence-dedicated processors, the artificial intelligence-dedicated processors may be designed in a hardware structure specialized for processing a specific artificial intelligence model.

The predefined operation rule or artificial intelligence model is created through training. Here, the creation through the training means that a predefined operation rule or artificial intelligence model set to perform a desired characteristic (or purpose) is created by training a basic artificial intelligence model using a plurality of training data by a training algorithm. Such training may be performed in an apparatus itself on which the artificial intelligence according to the disclosure is performed or may be performed through a separate server and/or system.

Examples of the learning algorithm include supervised learning, unsupervised learning, semi-supervised learning, or reinforcement learning, but are not limited thereto.

The artificial intelligence model includes a plurality of artificial neural networks, and the artificial neural network may include a plurality of neural network layers. Each of the plurality of neural network layers has a plurality of weight values, and performs a neural network calculation through a calculation between a calculation result of a previous layer and the plurality of weights. The plurality of weights of the plurality of neural network layers may be optimized by a training result of the artificial intelligence model. For example, the plurality of weights may be updated so that a loss value or a cost value obtained from the artificial intelligence model during a training process is decreased or minimized.

Examples of the artificial neural network include a convolutional neural network (CNN), a deep neural network (DNN), a recurrent neural network (RNN), a restricted Boltzmann machine (RBM), a deep belief network (DBN), a bidirectional recurrent deep neural network (BRDNN), deep Q-Networks, and the like, and the artificial neural network in the disclosure is not limited to the example described above except for a case where it is specified.

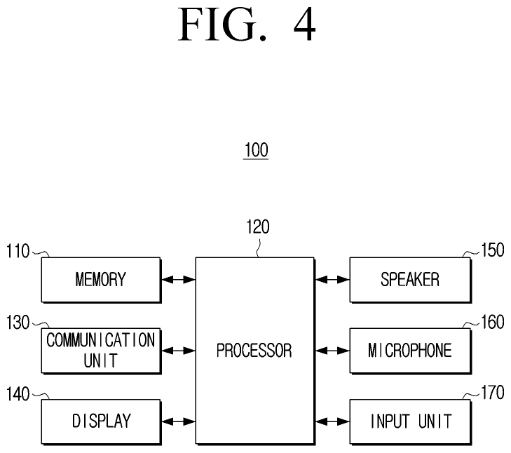

FIG. 4 is a block diagram illustrating in detail the configuration of the electronic device 100 according to the embodiment of the present disclosure. As illustrated in FIG. 4, the electronic device 100 may include the memory 110, the processor 120, a communication unit 130, a display 140, a speaker 150, a microphone 160, and an input unit 170. The memory 110 and the processor 120 have been described in detail with reference to FIGS. 1 and 2, and an overlapping description will thus be omitted.

The communication unit 130 may perform communication with the external device, including a circuit. In this case, the communication connection of the external apparatus with the communication unit 130 may be performed through a third device (for example, a repeater, a hub, an access point, a server, a gateway, or the like).

The communication unit 130 may include various communication modules to perform communication with an external device. For example, the communication unit 120 may include a wireless communication module, and for example, may include a cellular communication module using at least one of 5TH generation (5G), LTE, LTE advance (LTE-A), code division multiple access (CDMA), wideband CDMA (WCDMA), and the like.

As another example, the wireless communication module may include at least one of, for example, wireless fidelity (WiFi), Bluetooth, Bluetooth low energy (BLE), Zigbee, radio frequency (RF), and a body area network (BAN). However, this is only one embodiment, and the communication unit 120 may include a wired communication module.

The communication unit 130 may transmit weight data to an external server in order to quantize a plurality of weight data included in a plurality of layers constituting the neural network model. In addition, the communication unit 130 may receive quantized weight data to and from the external server.

The communication unit 130 may receive various types of first input data from an external device communicatively connected to the electronic device 100. For example, the communication unit 130 may receive various types of first input data from an input device (e.g., a camera, a microphone, a keyboard, etc.) connected to the electronic device 100 through wireless communication or an external server capable of providing various contents.

The display 140 may display various pieces of information according to the control of the processor 120. In particular, the display 140 may display the first input data or display the second output data obtained by performing the calculation between the weight data and the input data. Here, displaying the second output data may include an operation of displaying a screen including text or images generated based on the second output data.

The display 140 may be implemented by various display technologies such as a liquid crystal display (LCD), an organic light emitting diode (OLED), an active-matrix OLED (AM-OLED), a liquid crystal on silicon (LcoS), and digital light processing (DLP). In addition, the display 140 may also be coupled to at least one of a front area, a side area, and a back area of the electronic device 100 in the form of a flexible display.

In addition, the display 140 may be implemented as a touch screen including a touch sensor.

The speaker 150 is a component that outputs various audio data on which various processing operations such as decoding, amplification, and noise filtering have been performed by an audio processing unit (not illustrated). In addition, the speaker 150 may output various notification sounds or voice messages.

For example, when the calculation result between the weight data and the input data by the neural network model, that is, the second output data is output, the speaker 150 may output a notification sound or the like indicating that the output data has been obtained.

The microphone 160 is a component capable of receiving voice from a user. The microphone 160 may be provided inside the electronic device 100, but may be provided outside the electronic device 100 and electrically connected to the electronic device 100. In addition, when the microphone 160 is provided on the outside, the microphone 160 may transmit a generated user voice signal to the processor 120 through a wired/wireless interface (e.g., Wi-Fi, Bluetooth).

The microphone 160 may receive a user voice including a wake-up word (or trigger word) capable of activating an artificial intelligence model composed of various artificial neural networks. Based on the user voice including the wake-up word being received through the microphone 160, the processor 120 may activate an artificial intelligence model and may perform the calculation between the weight data using the user voice as the first input data.

The input unit 170 includes a circuit and may receive a user input for controlling the electronic device 100. In particular, the input unit 170 may include a touch panel for receiving a user touch using a user's hand, a stylus pen or the like, a button for receiving a user manipulation, and the like. As another example, the input unit 170 may be implemented as another input device (e.g., a keyboard, a mouse, or a motion input). Meanwhile, the input unit 170 may receive the first input data input from a user or receive various user commands.

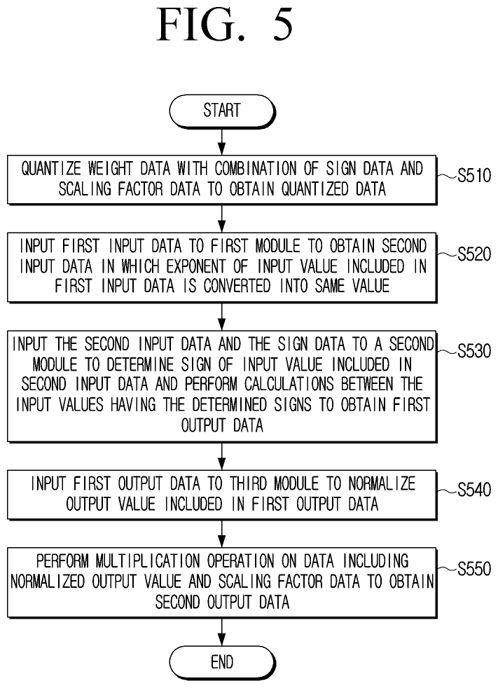

FIG. 5 is a flowchart illustrating a method of controlling an electronic device 100 according to an embodiment of the present disclosure.

The electronic device 100 may quantize weight data with a combination of sign data and scaling factor data to obtain quantized data (S510). For example, the electronic device 100 may quantize the weight data in a method of summing products of k pieces of sign data and scaling factor data. A size of k may be determined based on an accuracy level required when calculating the neural network model. Also, the scaling factor may be implemented as floating-point data.

The electronic device 100 may input the first input data to the first module to obtain the second input data in which exponents of input values included in the first input data are converted into the same value (S520).

For example, the electronic device 100 may identify a minimum exponent of the input values included in the first input data through the first module and convert the exponents of the input values included in the first input data into the identified minimum exponent value to obtain the second input data. However, this is only an example, and the electronic device 100 may align the exponents of the input values included in the first input data with a preset value through the first model.

The electronic device 100 inputs the second input data and the sign data to the second module to determine signs of input values included in the second input data, and performs the calculation between the input values of which signs are determined to obtain the first output data (S530).

Specifically, the electronic device 100 may apply one of −1 or 1 included in the sign data to the input value included in the second input data through the second module to determine the sign of the input value included in the second input data.

For example, the second module may include a plurality of calculation modules having the systolic array, and each of the plurality of calculation modules may include a sign determination circuit that determines the sign of the second input data using the sign data and a calculation circuit that performs the sum calculation between the input values included in the second input data of which signs are determined.

In this case, the electronic device 100 may input the first input value among the second input data and the sign value corresponding to the first input value among the sign data to the first sign determination circuit included in the first calculation module among the plurality of calculation modules to determine the sign of the first input value.

The electronic device 100 may input the first input value of which signs are determined and the second input value output from the second calculation module disposed above the first calculation module on the systolic array to the first calculation circuit among the first calculation modules to obtain the sum of the first input value and the second input value.

The electronic device 100 may input the first output data to the third module to normalize the output value included in the first output data (S540). Specifically, the electronic device 100 may change the first digit of the mantissa of the output value included in the first output data to be a one-digit natural number smaller than the base through the third model to normalize the output value included in the first output data.

The electronic device 100 may perform the multiplication operation on the data including the normalized output values and the scaling factor data to obtain the second output data (S550).

Meanwhile, it is to be understood that the drawings accompanied in this disclosure are not intended to limit the technology described in this disclosure to specific embodiments, but include all modifications, equivalents, and/or alternatives according to embodiments of the disclosure. Throughout the accompanying drawings, similar components will be denoted by similar reference numerals.

In the disclosure, an expression “have,” “may have,” “include,” or “may include” indicates existence of a corresponding feature (for example, a numerical value, a function, an operation, or a component such as a part), and does not exclude existence of an additional feature.

In the disclosure, an expression “A or B,” “at least one of A and/or B,” or “one or more of A and/or B,” may include all possible combinations of items enumerated together. For example, “A or B,” “at least one of A and B,” or “at least one of A or B” may indicate all of 1) a case where at least one A is included, 2) a case where at least one B is included, or 3) a case where both of at least one A and at least one B are included.

Expressions “first” or “second” used in the disclosure may indicate various components regardless of a sequence and/or importance of the components, will be used only to distinguish one component from the other components, and do not limit the corresponding components.

When it is mentioned that any component (for example, a first component) is (operatively or communicatively) coupled to or is connected to another component (for example, a second component), it is to be understood that any component is directly coupled to another component or may be coupled to another component through the other component (for example, a third component). On the other hand, when it is mentioned that any component (for example, a first component) is “directly coupled” or “directly connected” to another component (for example, a second component), it is to be understood that the other component (for example, a third component) is not present between any component and another component.

An expression “˜configured (or set) to” used in the disclosure may be replaced by an expression “˜suitable for,” “having the capacity to,” “˜designed to,” “˜adapted to,” “˜made to,” or “˜capable of” depending on a situation. A term “˜configured (or set) to” may not necessarily mean “specifically designed to” in hardware. Instead, in some situations, an expression “˜apparatus configured to” may mean that the apparatus may “do” together with other apparatuses or components. For example, a “sub-processor configured (or set) to perform A, B, and C” may mean a dedicated processor (for example, an embedded processor) for performing the corresponding operations or a generic-purpose processor (for example, a central processing unit (CPU) or an application processor) that may perform the corresponding operations by executing one or more software programs stored in a memory device.

The diverse embodiments of the disclosure may be implemented by software including instructions stored in a machine-readable storage medium (for example, a computer-readable storage medium). A machine may be an apparatus that invokes the stored instruction from the storage medium and may operate according to the invoked instruction, and may include the server cloud according to the disclosed embodiments. In a case where a command is executed by the processor, the processor may directly perform a function corresponding to the command or other components may perform the function corresponding to the command under a control of the processor.

The command may include codes created or executed by a compiler or an interpreter. The machine-readable storage medium may be provided in the form of a non-transitory storage medium. Here, the term “non-transitory storage medium” means that the storage medium is tangible without including a signal, and does not distinguish whether data are semi-permanently or temporarily stored in the storage medium. For example, the “non-transitory storage medium” may include a buffer in which data is temporarily stored.

According to an embodiment, the methods according to the diverse embodiments disclosed in the disclosure may be included and provided in a computer program product. The computer program product may be traded as a product between a seller and a purchaser. The computer program product may be distributed in the form of a storage medium (for example, a compact disc read only memory (CD-ROM)) that may be read by the machine or online through an application store (for example, PlayStore™). In case of the online distribution, at least a portion of the computer program product (for example, downloadable app) may be at least temporarily stored in the storage medium such as a memory of a server of a manufacturer, a server of an application store, or a relay server or be temporarily generated.

Each of components (for example, modules or programs) according to the diverse embodiments may include a single entity or a plurality of entities, and some of the corresponding sub-components described above may be omitted or other sub-components may be further included in the diverse embodiments. Alternatively or additionally, some of the components (e.g., the modules or the programs) may be integrated into one entity, and may perform functions performed by the respective corresponding components before being integrated in the same or similar manner. Operations performed by the modules, the programs, or other components according to the diverse embodiments may be executed in a sequential manner, a parallel manner, an iterative manner, or a heuristic manner, at least some of the operations may be performed in a different order or be omitted, or other operations may be added.

What is claimed is:

1. An electronic device, comprising:
a memory configured to store first input data and weight data used for calculation of a neural network model; and
a processor configured to quantize the weight data with a combination of sign data and scaling factor data to obtain quantized data,
wherein the processor is further configured to:
input the first input data to a first module to obtain second input data in which exponents of input values included in the first input data are converted into a same value;
input the second input data and the sign data to a second module to determine signs of the input values included in the second input data, and perform calculations between the input values of which signs are determined to obtain first output data;
input the first output data to a third module to normalize output values included in the first output data; and
perform a multiplication operation on data including the normalized output values and the scaling factor data to obtain second output data.

2. The electronic device of claim 1, wherein the processor is further configured to:
identify a minimum value among the exponents of the input values included in the first input data, and converts the exponents of the input values included in the first input data into the identified minimum value to obtain the second input data.

3. The electronic device of claim 1, wherein the processor is further configured to:
determine a sign of an input value among the input values included in the second input data based on applying one of a −1 or a 1 included in the sign data to the input value among the input values included in the second input data.

4. The electronic device of claim 1, wherein the second module includes a plurality of calculation modules having a systolic array, and
each of the plurality of calculation modules includes a sign determination circuit that determines a sign of the second input data using the sign data and a calculation circuit that performs a sum calculation between the input values included in the second input data of which the signs are determined.

5. The electronic device of claim 4, wherein the processor is further configured to:
input a first input value among the second input data and a sign value corresponding to the first input value among the sign data to a first sign determination circuit included in a first calculation module among the plurality of calculation modules to determine the sign of the first input value.

6. The electronic device of claim 5, wherein the processor is further configured to:
input the first input value of which the signs are determined and a second input value output from a second calculation module disposed above the first calculation module on the systolic array to a first calculation circuit among the first calculation module to obtain a sum of the first input value and the input values included in the second input data.

7. The electronic device of claim 1, wherein the processor is further configured to:
change a first digit of a mantissa of the output value included in the first output data to be a one-digit natural number smaller than a base to normalize the output value included in the first output data.

8. The electronic device of claim 1, wherein at least one of the scaling factor data and the first input data is implemented as data in a floating-point format.

9. The electronic device of claim 1, wherein the processor is further configured to:
quantize the weight data by summing k products of the sign data and the scaling factor data, and
a size of k is determined based on an accuracy level required when performing the calculation of the neural network model.

10. A method of controlling an electronic device including a memory that stores first input data and weight data used for calculation of a neural network model, the method comprising:
quantizing the weight data with a combination of sign data and scaling factor data to obtain quantized data;
inputting the first input data to a first module to obtain second input data in which exponents of input values included in the first input data are converted into a same value;
inputting the second input data and the sign data to a second module to determine signs of the input values included in the second input data, and performing calculation between the input values of which signs are determined to obtain first output data;
inputting the first output data to a third module to normalize output values included in the first output data; and
performing a multiplication operation on data including the normalized output values and the scaling factor data to obtain second output data.

11. The method of claim 10, wherein the obtaining of the second input data comprises identifying a minimum value among the exponents of the input values included in the first input data, and converting the exponents of the input values included in the first input data into the identified minimum value to obtain the second input data.

12. The method of claim 10, wherein the obtaining of the first output data comprises applying one of a −1 or a 1 included in the sign data to a input value among the input values included in the second input data to determine a sign of the input value among the input values included in the second input data.

13. The method of claim 10, wherein the second module comprises a plurality of calculation modules having a systolic array, and
each of the plurality of calculation modules comprises a sign determination circuit that determines a sign of the second input data using the sign data and a calculation circuit that performs a sum calculation between the input values included in the second input data of which the signs are determined.

14. The method of claim 13, wherein the obtaining of the first output data comprises inputting a first input value among the second input data and a sign value corresponding to the first input value among the sign data to a first sign determination circuit included in a first calculation module among the plurality of calculation modules to determine the sign of the first input value.

15. The method of claim 14, wherein the obtaining of the first output data comprises inputting the first input value of which the signs are determined and a second input value output from a second calculation module disposed above the first calculation module on the systolic array to a first calculation circuit among the first calculation module to obtain a sum of the first input value and the input values included in the second input data.

16. The method of claim 10, wherein the inputting the first output data to the third module to normalize output values included in the first output data comprises changing a first digit of a mantissa of the output value included in the first output data to be a one-digit natural number smaller than a base to normalize the output value included in the first output data.

17. The method of claim 10, wherein at least one of the scaling factor data and the first input data is implemented as data in a floating-point format.

18. The method of claim 10, wherein the quantizing the weight data comprises quantizing the weight data by summing k products of the sign data and the scaling factor data, and
wherein a size of k is determined based on an accuracy level required when performing the calculation of the neural network model.

19. A non-transitory computer readable recording medium storing a program for executing an operating method, the operating method including:
quantizing weight data with a combination of sign data and scaling factor data to obtain quantized data;
inputting a first input data to a first module to obtain second input data in which exponents of input values included in the first input data are converted into a same value;
inputting the second input data and the sign data to a second module to determine signs of the input values included in the second input data, and performing calculation between the input values of which signs are determined to obtain first output data;
inputting the first output data to a third module to normalize output values included in the first output data; and
performing a multiplication operation on data including the normalized output values and the scaling factor data to obtain second output data.

20. The non-transitory computer readable recording medium of claim 19,
wherein the obtaining of the second input data comprises identifying a minimum value among the exponents of the input values included in the first input data, and converting the exponents of the input values included in the first input data into the identified minimum value to obtain the second input data.
